(19) United States
(12) Patent Application Publication
(10) Pub. No.: US 2015/0021182 A1
(43) Pub. Date: Jan. 22, 2015

(54) METHODS OF MAINTAINING DROPLET TRANSPORT

(71) Applicant: ADVANCED LIQUID LOGIC, INC., Research Triangle Park, NC (US)

(72) Inventors: ARNAUD RIVAL, ST. MARTIN D'HERES (FR); CYRIL DELATTRE, IZEAUX (FR)

(73) Assignee: ADVANCED LIQUID LOGIC, INC., RESEARCH TRIANGLE PARK, NC (US)

(21) Appl. No.: 14/337,903

(22) Filed: Jul. 22, 2014

Related U.S. Application Data
(60) Provisional application No. 61/856,815, filed on Jul. 22, 2013.
(60) Provisional application No. 61/858,145, filed on Jul. 25, 2013.

(51) Int. Cl. B01L 3/02; B01L 3/00

(52) U.S. Cl. CPC B01L 3/0268; B01L 3/502761; B01L 2200/06; B01L 2400/0427
USPC 204/450; 204/601

(57) ABSTRACT

The invention provides a method for reducing or preventing droplet pinning as the droplet is transported across a boundary between a ground electrode region and a non-ground electrode region on a droplet actuator. The invention also provides a method for reducing or preventing droplet super-movement as the droplet is transported across a boundary between a ground electrode region and a non-ground electrode region on a droplet actuator.

### 1 RELATED APPLICATIONS

In addition to the patent applications cited herein, each of which is incorporated herein by reference, this patent application is related to and claims priority to U.S. Provisional Patent Application No. 61/856,815, filed on Jul. 22, 2013, entitled “Methods of Maintaining Droplet Transport;” and U.S. Provisional Patent Application No. 61/858,145, filed on Jul. 25, 2013, entitled “Methods of Maintaining Droplet Transport;” the entire disclosures of which are incorporated herein by reference.

### 2 FIELD OF THE INVENTION

The present invention generally relates to droplet actuators and methods for their use. In particular, the present invention provides methods for reducing or preventing droplet “pinning” or “super-movement” as the droplet is transported across a boundary between a ground-electrode-region and a non-ground-electrode-region of a droplet actuator.

### 3 BACKGROUND

A droplet actuator typically includes one or more substrates configured to form a surface or gap for conducting droplet operations. The one or more substrates establish a droplet operations surface or gap for conducting droplet operations and may also include electrodes arranged to conduct the droplet operations. The droplet operations substrate or the gap between the substrates may be coated or filled with a filler fluid that is immiscible with the liquid that forms the droplets. There is a need in the art for improved methods of transporting a droplet.

### 4 SUMMARY

The invention provides a method for reducing or preventing droplet pinning as the droplet is transported across a boundary between a ground electrode region and a non-ground electrode region on a droplet actuator, comprising: (a) providing the droplet actuator, wherein the droplet actuator comprises: (i) a bottom substrate and a top substrate separated to form a droplet operations gap; (ii) a ground electrode disposed on a portion of the top substrate; and (iii) a linear arrangement of a plurality of droplet operations electrodes disposed on the bottom substrate, wherein the plurality of droplet operations electrodes spans the boundary between the ground electrode region and the non-ground electrode region; (b) positioning an elongated droplet on more than one of the plurality of droplet operations electrodes, wherein the elongated droplet is positioned atop at least one droplet operations electrode in the ground electrode region and at least one droplet operations electrode in the non-ground electrode region; (c) activating the at least one droplet operations electrode in the non-ground electrode region; and (d) activating the next droplet operations electrode of the linear arrangement in the non-ground electrode region and deactivating the at least one droplet operations electrode in the non-ground electrode region; wherein the elongated droplet is transported out of the ground-electrode-region and into the non-ground electrode-region. In one embodiment, the ground-electrode-region comprises the ground electrode, and the ground electrode comprises a layer of electrically conductive material, particularly wherein the layer of electrically conductive material comprises poly(3,4-ethylenedioxythiophene) (PEDOT). In another embodiment, the non-ground electrode-region does not comprise the ground electrode. In a further embodiment, a hydrophobic layer is disposed on the surface of the top substrate facing the droplet operations gap, particularly wherein the hydrophobic layer comprises an amorphous fluoropolymer. In yet another embodiment, the hydrophobic layer is a sufficient thickness to facilitate droplet transport across the boundary between the ground-electrode-region and the non-ground electrode-region, particularly wherein the thickness of the hydrophobic layer is about 5 μm. In another embodiment, the top substrate further comprises a dielectric layer, particularly wherein the dielectric layer comprises polyimide. In another embodiment, activation of droplet operations electrodes comprises activation using an alternating current. In another embodiment, activation of droplet operations electrodes comprises activation using a direct current. In a further embodiment, the method further comprises providing a path of conductive material on the top substrate that spans the boundary between the ground electrode region and the non-ground electrode region of the droplet actuator, particularly wherein the path of electrically conductive material comprises poly(3,4-ethylenedioxythiophene) (PEDOT). In another embodiment, the path of electrically conductive material is of a width sufficient to facilitate droplet transport across boundary between the ground electrode region and the non-ground electrode region of the droplet actuator, particularly wherein the width of the path of electrically conductive material is about 120 μm.

In another embodiment, the invention provides a method for reducing or preventing droplet super-movement as the droplet is transported across a boundary between a ground electrode region and a non-ground electrode region on a droplet actuator, comprising: (a) providing the droplet actuator, wherein the droplet actuator comprises: (i) a bottom substrate and a top substrate separated to form a droplet operations gap, wherein the top substrate is deionized; (ii) a ground electrode disposed on a portion of the top substrate; and (iii) an arrangement of droplet operations electrodes disposed on the bottom substrate; and (b) transporting the droplet out of the ground electrode region and into the non-ground electrode region by electrowetting.

In another embodiment, the invention provides a method for reducing or preventing droplet super-movement as the droplet is transported across a boundary between a ground electrode region and a non-ground electrode region on a droplet actuator, comprising: (a) providing the droplet actuator, wherein the droplet actuator comprises: (i) a bottom substrate and a top substrate separated to form a droplet operations gap, wherein a portion of the top substrate facing away from the droplet operations gap is coated with a conductive coating; (ii) a ground electrode disposed on a portion of the top substrate; and (iii) an arrangement of droplet operations electrodes disposed on the bottom substrate; and (b) transporting the droplet out of the ground electrode region and into the non-ground electrode region by electrowetting. In one embodiment, the conductive coating comprises a continuous layer on the top substrate. In another embodiment, the conductive coating comprises an array of islands of conductive material on the top substrate. In a further embodiment, the conductive coating comprises lines of conductive material in a grid pattern on the top substrate. In yet another embodiment, the conductive coating comprises Poly(3,4-ethylenedioxythiophene) Polystyrene sulfonate.

### 5 BRIEF DESCRIPTION OF THE DRAWINGS

FIGS. 1A through 4B illustrate cross-sectional side views and top views of an example of a portion of a droplet actuator and show a process of transporting a droplet across the boundary between an area on a top substrate that includes a ground electrode and a conductive coating and an adjacent area that is absent the ground electrode and conductive coating;

FIG. 5 illustrates a top view of the droplet actuator of FIGS. 1A through 4B, wherein the coverage of the electrically conductive material is reduced in the region of the top substrate that includes the ground electrode;

FIG. 6 illustrates a top view of the droplet actuator of FIGS. 1A through 4B, wherein a portion of the surface of the top substrate facing away from the droplet operations gap includes a conductive coating; and

FIG. 7 illustrates a functional block diagram of an example of a microfluidics system that includes a droplet actuator.

### 6 DEFINITIONS

As used herein, the following terms have the meanings indicated.

“Activate,” with reference to one or more electrodes, means affecting a change in the electrical state of the one or more electrodes which, in the presence of a droplet, results in a droplet operation. Activation of an electrode can be accomplished using alternating current (AC) or direct current (DC). Any suitable voltage may be used. For example, an electrode may be activated using a voltage which is greater than about 150 V, or greater than about 200 V, or greater than about 250 V, or from about 275 V to about 1000 V, or about 300 V. Where an AC signal is used, any suitable frequency may be employed. For example, an electrode may be activated using an AC signal having a frequency from about 1 Hz to about 10 MHz, or from about 10 Hz to about 60 Hz, or from about 20 Hz to about 40 Hz, or about 30 Hz.

“Bead,” with respect to beads on a droplet actuator, means any bead or particle that is capable of interacting with a droplet on or in proximity with a droplet actuator. Beads may be any of a wide variety of shapes, such as spherical, generally spherical, egg shaped, disc shaped, cubical, amorphous and other three dimensional shapes. The bead may, for example, be capable of being subjected to a droplet operation in a droplet on a droplet actuator or otherwise configured with respect to a droplet actuator in a manner which permits a droplet on the droplet actuator to be brought into contact with the bead on the droplet actuator and/or off the droplet actuator. Beads may be provided in a droplet, in a droplet operations gap, or on a droplet operations surface. Beads may be provided in a reservoir that is external to a droplet operations gap or situated apart from a droplet operations surface, and the reservoir may be associated with a flow path that permits a droplet including the beads to be brought into a droplet operations gap or into contact with a droplet operations surface. Beads may be manufactured using a wide variety of materials, including for example, resins, and polymers. The beads may be any suitable size, including for example, microbeads, microparticles, nanobeads and nanoparticles. In some cases, beads are magnetically responsive; in other cases beads are not significantly magnetically responsive. For magnetically responsive beads, the magnetically responsive material may constitute substantially all of a bead, a portion of a bead, or only one component of a bead. The remainder of the bead may include, among other things, polymeric material, coatings, and moieties which permit attachment of an assay reagent. Examples of suitable beads include flow cytometry microbeads, polystyrene microparticles and nanoparticles, functionalized polystyrene microparticles and nanoparticles, coated polystyrene microparticles and nanoparticles, silica microbeads, fluorescent microspheres and nanospheres, functionalized fluorescent microspheres and nanospheres, coated fluorescent microspheres and nanospheres, color dyed microparticles and nanoparticles, magnetic microparticles and nanoparticles, superparamagnetic microparticles and nanoparticles (e.g., DYNABEADS® particles, available from Invitrogen Group, Carlsbad, Calif.), fluorescent microparticles and nanoparticles, coated magnetic microparticles and nanoparticles, ferromagnetic microparticles and nanoparticles, coated ferromagnetic microparticles and nanoparticles, and those described in U.S. Patent Publication Nos. 20050260686, entitled “Multiplex flow assays preferably with magnetic particles as solid phase,” published on Nov. 24, 2005; 20030132538, entitled “Encapsulation of discrete quanta of fluorescent particles,” published on Jul. 17, 2003; 20050118574, entitled “Multiplexed Analysis of Clinical Specimens Apparatus and Method,” published on Jun. 2, 2005; 20050277197. Entitled “Microparticles with Multiple Fluorescent Signals and Methods of Using Same,” published on Dec. 15, 2005; 20060159962, entitled “Magnetic Microspheres for use in Fluorescence-based Applications,” published on Jul. 20, 2006; the entire disclosures of which are incorporated herein by reference for their teaching concerning beads and magnetically responsive materials and beads. Beads may be pre-coupled with a biomolecule or other substance that is able to bind to and form a complex with a biomolecule. Beads may be pre-coupled with an antibody, protein or antigen, DNA/RNA probe or any other molecule with an affinity for a desired target. Examples of droplet actuator techniques for immobilizing magnetically responsive beads and/or non-magnetically responsive beads and/or conducting droplet operations protocols using beads are described in U.S. patent application Ser. No. 11/639,566, entitled “Droplet-Based Particle Sorting,” filed on Dec. 15, 2006; U.S. Patent Application No. 61/039,183, entitled “Multiplexing Bead Detection in a Single Droplet,” filed on Mar. 25, 2008; U.S. Patent Application No. 61/047,789, entitled “Droplet Actuator Devices and Droplet Operations Using Beads,” filed on Apr. 25, 2008; U.S. Patent Application No. 61/086,183, entitled “Droplet Actuator Devices and Methods for Manipulating Beads,” filed on Aug. 5, 2008; International Patent Application No. PCT/US2008/053545, entitled “Droplet Actuator Devices and Methods Employing Magnetic Beads,” filed on Feb. 11, 2008; International Patent Application No. PCT/US2008/058018, entitled “Bead-based Multiplexed Analytical Methods and Instrumentation,” filed on Mar. 24, 2008; International Patent Application No. PCT/US2008/058047, “Bead Sorting on a Droplet Actuator,” filed on Mar. 23, 2008; and International Patent Application No. PCT/US2006/047486, entitled “Droplet-based Biochemistry,” filed on Dec. 11, 2006; the entire disclosures of which are incorporated herein by reference. Bead characteristics may be employed in the multiplexing aspects of the invention. Examples of beads having characteristics suitable for multiplexing, as well as methods of detecting and analyzing signals emitted from such beads, may be found in U.S. Patent Publication No. 20080305481, entitled “Systems and Methods for Multiplex Analysis of PCR in Real Time,” published on Dec. 11, 2008; U.S. Patent Publication No. 20080151240, “Methods and Systems for Dynamic Range Expansion,” published on Jun. 26, 2008; U.S. Patent Publication No. 20070207513, entitled “Methods, Products, and Kits for Identifying an Analyte in a Sample,” published on Sep. 6, 2007; U.S. Patent Publication No. 20070064990, entitled “Methods and Systems for Image Data Processing,” published on Mar. 22, 2007; U.S. Patent Publication No. 20060159962, entitled “Magnetic Microspheres for use in Fluorescence-based Applications,” published on Jul. 20, 2006; U.S. Patent Publication No. 20050277197, entitled “Microparticles with Multiple Fluorescent Signals and Methods of Using Same,” published on Dec. 15, 2005; and U.S. Patent Publication No. 20050118574, entitled “Multiplexed Analysis of Clinical Specimens Apparatus and Method,” published on Jun. 2, 2005.

“Droplet” means a volume of liquid on a droplet actuator. Typically, a droplet is at least partially bounded by a filler fluid. For example, a droplet may be completely surrounded by a filler fluid or may be bounded by filler fluid and one or more surfaces of the droplet actuator. As another example, a droplet may be bounded by filler fluid, one or more surfaces of the droplet actuator, and/or the atmosphere. As yet another example, a droplet may be bounded by filler fluid and the atmosphere. Droplets may, for example, be aqueous or non-aqueous or may be mixtures or emulsions including aqueous and non-aqueous components. Droplets may take a wide variety of shapes; nonlimiting examples include generally disc shaped, slug shaped, truncated sphere, ellipsoid, spherical, partially compressed sphere, hemispherical, ovoid, cylindrical, combinations of such shapes, and various shapes formed during droplet operations, such as merging or splitting or formed as a result of contact of such shapes with one or more surfaces of a droplet actuator. For examples of droplet fluids that may be subjected to droplet operations using the approach of the invention, see International Patent Application No. PCT/US 06/47486, entitled, “Droplet-Based Biochemistry,” filed on Dec. 11, 2006. In various embodiments, a droplet may include a biological sample, such as whole blood, lymphatic fluid, serum, plasma, sweat, tear, saliva, sputum, cerebrospinal fluid, amniotic fluid, seminal fluid, vaginal excretion, serous fluid, synovial fluid, pericardial fluid, peritoneal fluid, pleural fluid, transudates, exudates, cystic fluid, bile, urine, gastric fluid, intestinal fluid, fecal samples, liquids containing single or multiple cells, liquids containing organelles, fluidized tissues, fluidized organisms, liquids containing multi-celled organisms, biological swabs and biological washes. Moreover, a droplet may include a reagent, such as water, deionized water, saline solutions, acidic solutions, basic solutions, detergent solutions and/or buffers. Other examples of droplet contents include reagents, such as a reagent for a biochemical protocol, such as a nucleic acid amplification protocol, an affinity-based assay protocol, an enzymatic assay protocol, a sequencing protocol, and/or a protocol for analyses of biological fluids. A droplet may include one or more beads.

“Droplet Actuator” means a device for manipulating droplets. For examples of droplet actuators, see Pamula et al., U.S. Pat. No. 6,911,132, entitled “Apparatus for Manipulating Droplets by Electrowetting-Based Techniques,” issued on Jun. 28, 2005; Pamula et al., U.S. patent application Ser. No. 11/343,284, entitled “Apparatuses and Methods for Manipulating Droplets on a Printed Circuit Board,” filed on filed on Jan. 30, 2006; Pollack et al., International Patent Application No. PCT/US2006/047486, entitled “Droplet-Based Biochemistry,” filed on Dec. 11, 2006; Shenderov, U.S. Pat. No. 6,773,566, entitled “Electrostatic Actuators for Microfluidics and Methods for Using Same,” issued on Aug. 10, 2004 and U.S. Pat. No. 6,565,727, entitled “Actuators for Microfluidics Without Moving Parts,” issued on Jan. 24, 2000; Kim and/or Shah et al., U.S. patent application Ser. No. 10/343,261, entitled “Electrowetting-driven Micropumping,” filed on Jan. 27, 2003, Ser. No. 11/275,668, entitled “Method and Apparatus for Promoting the Complete Transfer of Liquid Drops from a Nozzle,” filed on Jan. 23, 2006, Ser. No. 11/460,188, entitled “Small Object Moving on Printed Circuit Board,” filed on Jan. 23, 2006, Ser. No. 12/465,935, entitled “Method for Using Magnetic Particles in Droplet Microfluidics,” filed on May 14, 2009, and Ser. No. 12/513,157, entitled “Method and Apparatus for Real-time Feedback Control of Electrical Manipulation of Droplets on Chip,” filed on Apr. 30, 2009; Velev, U.S. Pat. No. 7,547,380, entitled “Droplet Transportation Devices and Methods Having a Fluid Surface,” issued on Jun. 16, 2009; Sterling et al., U.S. Pat. No. 7,163,612, entitled “Method, Apparatus and Article for Microfluidic Control via Electrowetting, for Chemical, Biochemical and Biological Assays and the Like,” issued on Jan. 16, 2007; Becker and Gascoyne et al., U.S. Pat. No. 7,641,779, entitled “Method and Apparatus for Programmable fluidic Processing,” issued on Jan. 5, 2010, and U.S. Pat. No. 6,977,033, entitled “Method and Apparatus for Programmable fluidic Processing,” issued on Dec. 20, 2005; Decre et al., U.S. Pat. No. 7,328,979, entitled “System for Manipulation of a Body of Fluid,” issued on Feb. 12, 2008; Yamakawa et al., U.S. Patent Pub. No. 20060039823, entitled “Chemical Analysis Apparatus,” published on Feb. 23, 2006; Wu, International Patent Pub. No. WO/2009/003184, entitled “Digital Microfluidics Based Apparatus for Heat-exchanging Chemical Processes,” published on Dec. 31, 2008; Fouillet et al., U.S. Patent Pub. No. 20090192044, entitled “Electrode Addressing Method,” published on Jul. 30, 2009; Fouillet et al., U.S. Pat. No. 7,052,244, entitled “Device for Displacement of Small Liquid Volumes Along a Micro-catenary Line by Electrostatic Forces,” issued on May 30, 2006; Marchand et al., U.S. Patent Pub. No. 20080124252, entitled “Droplet Microreactor,” published on May 29, 2008; Adachi et al., U.S. Patent Pub. No. 20090321262, entitled “Liquid Transfer Device,” published on Dec. 31, 2009; Roux et al., U.S. Patent Pub. No. 20050179746, entitled “Device for Controlling the Displacement of a Drop Between two or Several Solid Substrates,” published on Aug. 18, 2005; Dhindsa et al., “Virtual Electrowetting Channels: Electronic Liquid Transport with Continuous Channel Functionality,” Lab Chip, 10:832-836 (2010); the entire disclosures of which are incorporated herein by reference, along with their priority documents. Certain droplet actuators will include one or more substrates arranged with a droplet operations gap therebetween and electrodes associated with (e.g., layered on, attached to, and/or embedded in) the one or more substrates and arranged to conduct one or more droplet operations. For example, certain droplet actuators will include a base (or bottom) substrate, droplet operations electrodes associated with the substrate, one or more dielectric layers atop the substrate and/or electrodes, and optionally one or more hydrophobic layers atop the substrate, dielectric layers and/or the electrodes forming a droplet operations surface. A top substrate may also be provided, which is separated from the droplet operations surface by a gap, commonly referred to as a droplet operations gap. Various electrode arrangements on the top and/or bottom substrates are discussed in the above-referenced patents and applications and certain novel electrode arrangements are discussed in the description of the invention. During droplet operations it is preferred that droplets remain in continuous contact or frequent contact with a ground or reference electrode. A ground or reference electrode may be associated with the top substrate facing the gap, the bottom substrate facing the gap, in the gap. Where electrodes are provided on both substrates, electrical contacts for coupling the electrodes to a droplet actuator instrument for controlling or monitoring the electrodes may be associated with one or both plates. In some cases, electrodes on one substrate are electrically coupled to the other substrate so that only one substrate is in contact with the droplet actuator. In one embodiment, a conductive material (e.g., an epoxy, such as MASTER BOND™ Polymer System EP79, available from Master Bond, Inc., Hackensack, N.J.) provides the electrical connection between electrodes on one substrate and electrical paths on the other substrates, e.g., a ground electrode on a top substrate may be coupled to an electrical path on a bottom substrate by such a conductive material. Where multiple substrates are used, a spacer may be provided between the substrates to determine the height of the gap therebetween and define dispensing reservoirs. The spacer height may, for example, be from about 5 μm to about 600 μm, or about 100 μm to about 400 μm, or about 200 μm to about 350 μm, or about 250 μm to about 300 μm, or about 275 μm. The spacer may, for example, be formed of a layer of projections form the top or bottom substrates, and/or a material inserted between the top and bottom substrates. One or more openings may be provided in the one or more substrates for forming a fluid path through which liquid may be delivered into the droplet operations gap. The one or more openings may in some cases be aligned for interaction with one or more electrodes, e.g., aligned such that liquid flowed through the opening will come into sufficient proximity with one or more droplet operations electrodes to permit a droplet operation to be effected by the droplet operations electrodes using the liquid. The base (or bottom) and top substrates may in some cases be formed as one integral component. One or more reference electrodes may be provided on the base (or bottom) and/or top substrates and/or in the gap. Examples of reference electrode arrangements are provided in the above referenced patents and patent applications. In various embodiments, the manipulation of droplets by a droplet actuator may be electrode mediated, e.g., electrowetting mediated or dielectrophoresis mediated or Coulombic force mediated. Examples of other techniques for controlling droplet operations that may be used in the droplet actuators of the invention include using devices that induce hydrodynamic fluidic pressure, such as those that operate on the basis of mechanical principles (e.g. external syringe pumps, pneumatic membrane pumps, vibrating membrane pumps, vacuum devices, centrifugal forces, piezoelectric/ultrasonic pumps and acoustic forces); electrical or magnetic principles (e.g. electroosmotic flow, electrokinetic pumps, ferrofluidic plugs, electrohydrodynamic pumps, attraction or repulsion using magnetic forces and magnetohydrodynamic pumps); thermodynamic principles (e.g. gas bubble generation/phase-change-induced volume expansion); other kinds of surface-wetting principles (e.g. electrowetting, and optoelectrowetting, as well as chemically, thermally, structurally and radioactively induced surface-tension gradients); gravity; surface tension (e.g., capillary action); electrostatic forces (e.g., electroosmotic flow); centrifugal flow (substrate disposed on a compact disc and rotated); magnetic forces (e.g., oscillating ions causes flow); magnetohydrodynamic forces; and vacuum or pressure differential. In certain embodiments, combinations of two or more of the foregoing techniques may be employed to conduct a droplet operation in a droplet actuator of the invention. Similarly, one or more of the foregoing may be used to deliver liquid into a droplet operations gap, e.g., from a reservoir in another device or from an external reservoir of the droplet actuator (e.g., a reservoir associated with a droplet actuator substrate and a flow path from the reservoir into the droplet operations gap). Droplet operations surfaces of certain droplet actuators of the invention may be made from hydrophobic materials or may be coated or treated to make them hydrophobic. For example, in some cases some portion or all of the droplet operations surfaces may be derivatized with low surface-energy materials or chemistries, e.g., by deposition or using in situ synthesis using compounds such as poly- or per-fluorinated compounds in solution or polymerizable monomers. Examples include TEFLON® AF (available from DuPont, Wilmington, Del.), members of the cytop family of materials, coatings in the FLUOROPEL® family of hydrophobic and superhydrophobic coatings (available from Cytonix Corporation, Beltsville, Md.), silane coatings, fluorosilane coatings, hydrophobic phosphonate derivatives (e.g., those sold by Aculon, Inc), and NOVEC™ electronic coatings (available from 3M Company, St. Paul, Minn.), other fluorinated monomers for plasma-enhanced chemical vapor deposition (PECVD), and organosiloxane (e.g., SiOC) for PECVD. In some cases, the droplet operations surface may include a hydrophobic coating having a thickness ranging from about 10 nm to about 1,000 nm. Moreover, in some embodiments, the top substrate of the droplet actuator includes an electrically conducting organic polymer, which is then coated with a hydrophobic coating or otherwise treated to make the droplet operations surface hydrophobic. For example, the electrically conducting organic polymer that is deposited onto a plastic substrate may be poly(3,4-ethylenedioxythiophene) poly(styrenesulfonate) (PEDOT:PSS). Other examples of electrically conducting organic polymers and alternative conductive layers are described in Pollack et al., International Patent Application No. PCT/US2010/040705, entitled “Droplet Actuator Devices and Methods,” the entire disclosure of which is incorporated herein by reference. One or both substrates may be fabricated using a printed circuit board (PCB), glass, indium tin oxide (ITO)-coated glass, and/or semiconductor materials as the substrate. When the substrate is ITO-coated glass, the ITO coating is preferably a thickness in the range of about 20 to about 200 nm, preferably about 50 to about 150 nm, or about 75 to about 125 nm, or about 100 nm. In some cases, the top and/or bottom substrate includes a PCB substrate that is coated with a dielectric, such as a polyimide dielectric, which may in some cases also be coated or otherwise treated to make the droplet operations surface hydrophobic. When the substrate includes a PCB, the following materials are examples of suitable materials: MITSUI™ BN-300 (available from MITSUI Chemicals America, Inc., San Jose Calif.); ARLON™ 11N (available from Arlon, Inc, Santa Ana, Calif.).; NELCO® N4000-6 and N5000-30/32 (available from Park Electrochemical Corp., Melville, N.Y.); ISOLA™ FR406 (available from Isola Group, Chandler, Ariz.), especially IS620; fluoropolymer family (suitable for fluorescence detection since it has low background fluorescence); polyimide family; polyester; polyethylene naphthalate; polycarbonate; polyetheretherketone; liquid crystal polymer; cyclo-olefin copolymer (COC); cyclo-olefin polymer (COP); aramid; THERMOUNT® nonwoven aramid reinforcement (available from DuPont, Wilmington, Del.); NOMEX® brand fiber (available from DuPont, Wilmington, Del.); and paper. Various materials are also suitable for use as the dielectric component of the substrate. Examples include: vapor deposited dielectric, such as PARYLENE™ C (especially on glass), PARYLENE™ N, and PARYLENE™ HT (for high temperature, ˜300° C.) (available from Parylene Coating Services, Inc., Katy, Tex.); TEFLON® AF coatings; cytop; soldermasks, such as liquid photoimageable soldermasks (e.g., on PCB) like TAIYO™ PSR4000 series, TAIYO™ PSR and AUS series (available from Taiyo America, Inc. Carson City, Nev.) (good thermal characteristics for applications involving thermal control), and PROBIMER™ 8165 (good thermal characteristics for applications involving thermal control (available from Huntsman Advanced Materials Americas Inc., Los Angeles, Calif.); dry film soldermask, such as those in the VACREL® dry film soldermask line (available from DuPont, Wilmington, Del.); film dielectrics, such as polyimide film (e.g., KAPTON® polyimide film, available from DuPont, Wilmington, Del.), polyethylene, and fluoropolymers (e.g., FEP), polytetrafluoroethylene; polyester; polyethylene naphthalate; cyclo-olefin copolymer (COC); cyclo-olefin polymer (COP); any other PCB substrate material listed above; black matrix resin; polypropylene; and black flexible circuit materials, such as DuPont™ Pyralux® HXC and DuPont™ Kapton® MBC (available from DuPont, Wilmington, Del. Droplet transport voltage and frequency may be selected for performance with reagents used in specific assay protocols. Design parameters may be varied, e.g., number and placement of on-actuator reservoirs, number of independent electrode connections, size (volume) of different reservoirs, placement of magnets/bead washing zones, electrode size, inter-electrode pitch, and gap height (between top and bottom substrates) may be varied for use with specific reagents, protocols, droplet volumes, etc. In some cases, a substrate of the invention may derivatized with low surface-energy materials or chemistries, e.g., using deposition or in situ synthesis using poly- or per-fluorinated compounds in solution or polymerizable monomers. Examples include TEFLON® AF coatings and FLUOROPEL® coatings for dip or spray coating, other fluorinated monomers for plasma-enhanced chemical vapor deposition (PECVD), and organosiloxane (e.g., SiOC) for PECVD. Additionally, in some cases, some portion or all of the droplet operations surface may be coated with a substance for reducing background noise, such as background fluorescence from a PCB substrate. For example, the noise-reducing coating may include a black matrix resin, such as the black matrix resins available from Toray industries, Inc., Japan. Electrodes of a droplet actuator are typically controlled by a controller or a processor, which is itself provided as part of a system, which may include processing functions as well as data and software storage and input and output capabilities. Reagents may be provided on the droplet actuator in the droplet operations gap or in a reservoir fluidly coupled to the droplet operations gap. The reagents may be in liquid form, e.g., droplets, or they may be provided in a reconstitutable form in the droplet operations gap or in a reservoir fluidly coupled to the droplet operations gap. Reconstitutable reagents may typically be combined with liquids for reconstitution. An example of reconstitutable reagents suitable for use with the invention includes those described in Meathrel, et al., U.S. Pat. No. 7,727,466, entitled “Disintegratable films for diagnostic devices,” granted on Jun. 1, 2010.

“Filler fluid” means a fluid associated with a droplet operations substrate of a droplet actuator, which fluid is sufficiently immiscible with a droplet phase to render the droplet phase subject to electrode-mediated droplet operations. For example, the droplet operations gap of a droplet actuator is typically filled with a filler fluid. The filler fluid may, for example, be or include a low-viscosity oil, such as silicone oil or hexadecane filler fluid. The filler fluid may be or include a halogenated oil, such as a fluorinated or perfluorinated oil. The filler fluid may fill the entire gap of the droplet actuator or may coat one or more surfaces of the droplet actuator. Filler fluids may be conductive or non-conductive. Filler fluids may be selected to improve droplet operations and/or reduce loss of reagent or target substances from droplets, improve formation of microdroplets, reduce cross contamination between droplets, reduce contamination of droplet actuator surfaces, reduce degradation of droplet actuator materials, etc. For example, filler fluids may be selected for compatibility with droplet actuator materials. As an example, fluorinated filler fluids may be usefully employed with fluorinated surface coatings. Fluorinated filler fluids are useful to reduce loss of lipophilic compounds, such as umbelliferone substrates like 6-hexadecanoylamido-4-methylumbelliferone substrates (e.g., for use in Krabbe, Niemann-Pick, or other assays); other umbelliferone substrates are described in U.S. Patent Pub. No. 20110118132, published on May 19, 2011, the entire disclosure of which is incorporated herein by reference. Examples of suitable fluorinated oils include those in the Galden line, such as Galden HT170 (bp=170° C., viscosity=1.8 cSt, density=1.77), Galden HT200 (bp=200C, viscosity=2.4 cSt, d=1.79), Galden HT230 (bp=230C, viscosity=4.4 cSt, d=1.82) (all from Solvay Solexis); those in the Novec line, such as Novec 7500 (bp=128C, viscosity=0.8 cSt, d=1.61), Fluorinert FC-40 (bp=155° C., viscosity=1.8 cSt, d=1.85), Fluorinert FC-43 (bp=174° C., viscosity=2.5 cSt, d=1.86) (both from 3M). In general, selection of perfluorinated filler fluids is based on kinematic viscosity (<7 cSt is preferred, but not required), and on boiling point (>150° C. is preferred, but not required, for use in DNA/RNA-based applications (PCR, etc.)). Filler fluids may, for example, be doped with surfactants or other additives. For example, additives may be selected to improve droplet operations and/or reduce loss of reagent or target substances from droplets, formation of microdroplets, cross contamination between droplets, contamination of droplet actuator surfaces, degradation of droplet actuator materials, etc. Composition of the filler fluid, including surfactant doping, may be selected for performance with reagents used in the specific assay protocols and effective interaction or non-interaction with droplet actuator materials. Examples of filler fluids and filler fluid formulations suitable for use with the invention are provided in Srinivasan et al, International Patent Pub. Nos. WO/2010/027894, entitled “Droplet Actuators, Modified Fluids and Methods,” published on Mar. 11, 2010, and WO/2009/021173, entitled “Use of Additives for Enhancing Droplet Operations,” published on Feb. 12, 2009; Sista et al., International Patent Pub. No. WO/2008/098236, entitled “Droplet Actuator Devices and Methods Employing Magnetic Beads,” published on Aug. 14, 2008; and Monroe et al., U.S. Patent Publication No. 20080283414, entitled “Electrowetting Devices,” filed on May 17, 2007; the entire disclosures of which are incorporated herein by reference, as well as the other patents and patent applications cited herein. Fluorinated oils may in some cases be doped with fluorinated surfactants, e.g., Zonyl FSO-100 (Sigma-Aldrich) and/or others.

“Immobilize” with respect to magnetically responsive beads, means that the beads are substantially restrained in position in a droplet or in filler fluid on a droplet actuator. For example, in one embodiment, immobilized beads are sufficiently restrained in position in a droplet to permit execution of a droplet splitting operation, yielding one droplet with substantially all of the beads and one droplet substantially lacking in the beads.

“Magnetically responsive” means responsive to a magnetic field. “Magnetically responsive beads” include or are composed of magnetically responsive materials. Examples of magnetically responsive materials include paramagnetic materials, ferromagnetic materials, ferrimagnetic materials, and metamagnetic materials. Examples of suitable paramagnetic materials include iron, nickel, and cobalt, as well as metal oxides, such as Fe3O4, BaFe12O19, CoO, NiO, Mn2O3, Cr2O3, and CoMnP.

“Reservoir” means an enclosure or partial enclosure configured for holding, storing, or supplying liquid. A droplet actuator system of the invention may include on-cartridge reservoirs and/or off-cartridge reservoirs. On-cartridge reservoirs may be (1) on-actuator reservoirs, which are reservoirs in the droplet operations gap or on the droplet operations surface; (2) off-actuator reservoirs, which are reservoirs on the droplet actuator cartridge, but outside the droplet operations gap, and not in contact with the droplet operations surface; or (3) hybrid reservoirs which have on-actuator regions and off-actuator regions. An example of an off-actuator reservoir is a reservoir in the top substrate. An off-actuator reservoir is typically in fluid communication with an opening or flow path arranged for flowing liquid from the off-actuator reservoir into the droplet operations gap, such as into an on-actuator reservoir. An off-cartridge reservoir may be a reservoir that is not part of the droplet actuator cartridge at all, but which flows liquid to some portion of the droplet actuator cartridge. For example, an off-cartridge reservoir may be part of a system or docking station to which the droplet actuator cartridge is coupled during operation. Similarly, an off-cartridge reservoir may be a reagent storage container or syringe which is used to force fluid into an on-cartridge reservoir or into a droplet operations gap. A system using an off-cartridge reservoir will typically include a fluid passage means whereby liquid may be transferred from the off-cartridge reservoir into an on-cartridge reservoir or into a droplet operations gap.

“Transporting into the magnetic field of a magnet,” “transporting towards a magnet,” and the like, as used herein to refer to droplets and/or magnetically responsive beads within droplets, is intended to refer to transporting into a region of a magnetic field capable of substantially attracting magnetically responsive beads in the droplet. Similarly, “transporting away from a magnet or magnetic field,” “transporting out of the magnetic field of a magnet,” and the like, as used herein to refer to droplets and/or magnetically responsive beads within droplets, is intended to refer to transporting away from a region of a magnetic field capable of substantially attracting magnetically responsive beads in the droplet, whether or not the droplet or magnetically responsive beads is completely removed from the magnetic field. It will be appreciated that in any of such cases described herein, the droplet may be transported towards or away from the desired region of the magnetic field, and/or the desired region of the magnetic field may be moved towards or away from the droplet. Reference to an electrode, a droplet, or magnetically responsive beads being “within” or “in” a magnetic field, or the like, is intended to describe a situation in which the electrode is situated in a manner which permits the electrode to transport a droplet into and/or away from a desired region of a magnetic field, or the droplet or magnetically responsive beads is/are situated in a desired region of the magnetic field, in each case where the magnetic field in the desired region is capable of substantially attracting any magnetically responsive beads in the droplet. Similarly, reference to an electrode, a droplet, or magnetically responsive beads being “outside of” or “away from” a magnetic field, and the like, is intended to describe a situation in which the electrode is situated in a manner which permits the electrode to transport a droplet away from a certain region of a magnetic field, or the droplet or magnetically responsive beads is/are situated away from a certain region of the magnetic field, in each case where the magnetic field in such region is not capable of substantially attracting any magnetically responsive beads in the droplet or in which any remaining attraction does not eliminate the effectiveness of droplet operations conducted in the region. In various aspects of the invention, a system, a droplet actuator, or another component of a system may include a magnet, such as one or more permanent magnets (e.g., a single cylindrical or bar magnet or an array of such magnets, such as a Halbach array) or an electromagnet or array of electromagnets, to form a magnetic field for interacting with magnetically responsive beads or other components on chip. Such interactions may, for example, include substantially immobilizing or restraining movement or flow of magnetically responsive beads during storage or in a droplet during a droplet operation or pulling magnetically responsive beads out of a droplet.

“Washing” with respect to washing a bead means reducing the amount and/or concentration of one or more substances in contact with the bead or exposed to the bead from a droplet in contact with the bead. The reduction in the amount and/or concentration of the substance may be partial, substantially complete, or even complete. The substance may be any of a wide variety of substances; examples include target substances for further analysis, and unwanted substances, such as components of a sample, contaminants, and/or excess reagent. In some embodiments, a washing operation begins with a starting droplet in contact with a magnetically responsive bead, where the droplet includes an initial amount and initial concentration of a substance. The washing operation may proceed using a variety of droplet operations. The washing operation may yield a droplet including the magnetically responsive bead, where the droplet has a total amount and/or concentration of the substance which is less than the initial amount and/or concentration of the substance. Examples of suitable washing techniques are described in Pamula et al., U.S. Pat. No. 7,439,014, entitled “Droplet-Based Surface Modification and Washing,” granted on Oct. 21, 2008, the entire disclosure of which is incorporated herein by reference.

The terms “top,” “bottom,” “over,” “under,” and “on” are used throughout the description with reference to the relative positions of components of the droplet actuator, such as relative positions of top and bottom substrates of the droplet actuator. It will be appreciated that the droplet actuator is functional regardless of its orientation in space.

When a liquid in any form (e.g., a droplet or a continuous body, whether moving or stationary) is described as being “on”, “at”, or “over” an electrode, array, matrix or surface, such liquid could be either in direct contact with the electrode/array/matrix/surface, or could be in contact with one or more layers or films that are interposed between the liquid and the electrode/array/matrix/surface. In one example, filler fluid can be considered as a film between such liquid and the electrode/array/matrix/surface.

When a droplet is described as being “on” or “loaded on” a droplet actuator, it should be understood that the droplet is arranged on the droplet actuator in a manner which facilitates using the droplet actuator to conduct one or more droplet operations on the droplet, the droplet is arranged on the droplet actuator in a manner which facilitates sensing of a property of or a signal from the droplet, and/or the droplet has been subjected to a droplet operation on the droplet actuator.

### 7 DESCRIPTION

The invention provides methods of maintaining droplet transport across a boundary between a first area and a second area on a top substrate of a droplet actuator, wherein the first area comprises a ground electrode and a conductive coating (a “ground-electrode-region”), and wherein the second area is adjacent to the first area and does not comprise a ground electrode or a conductive coating (a “non-ground-electrode-region”). In another embodiment, the invention provides methods for reducing or entirely preventing droplet “pinning” or “pull-back” as the droplet is transported across a boundary between a ground-electrode-region and a non-ground-electrode-region on a top substrate of a droplet actuator. In another embodiment, the invention provides methods for reducing or entirely preventing random movement (i.e., “super-movement”) of a droplet as the droplet is transported across a boundary between a ground-electrode-region and a non-ground-electrode-region on a top substrate of a droplet actuator.

### 7.1 Methods for Maintaining Droplet Transport

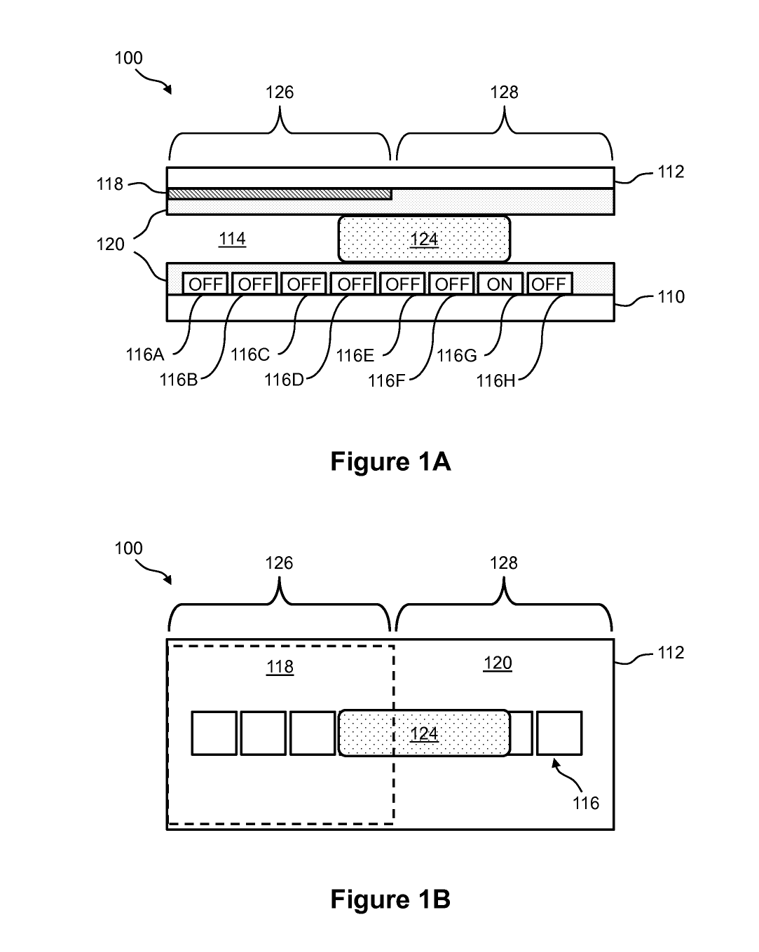

FIGS. 1A through 4B illustrate cross-sectional side views and top views of an example of a portion of a droplet actuator 100 and show a process of transporting a droplet across a boundary between a first area and a second area on a top substrate of a droplet actuator, wherein the first area comprises a ground electrode and a conductive coating (hereinafter a “ground-electrode-region”), and wherein the second area is adjacent to the first area and does not comprise a ground electrode (hereinafter a “non-ground-electrode-region”).

Droplet actuator 100 may include a bottom substrate 110 and a top substrate 112 that are separated by a droplet operations gap 114. Droplet operations are conducted in the droplet operations gap 114 on a droplet operations surface. An arrangement of droplet operations electrodes 116 (e.g., electrowetting electrodes), i.e., droplet operations electrode 116A through 116H, may be disposed on bottom substrate 110. A ground electrode 118 may be disposed on a portion of top substrate 112. Droplet operations electrodes 116 and ground electrode 118 are arranged for conducting droplet operations.

Ground electrode 118 is a layer of electrically conductive material. In one example, ground electrode 118 is formed using a layer of poly(3,4-ethylenedioxythiophene) (PEDOT). A ground-electrode-region 126 of top substrate 112 is defined by ground electrode 118. Similarly, a non-ground-electrode-region 128 of top substrate 112 is defined by the absence of ground electrode 118. A hydrophobic layer 120 is disposed on the entire surface of top substrate 112 that is facing droplet operations gap 114. Similarly, another hydrophobic layer 120 is disposed on the surface of bottom substrate 110 that is facing droplet operations gap 114 (i.e., atop droplet operations electrodes 116). In one example, hydrophobic layers 120 are formed of CYTOP.

A droplet 124 may be positioned in droplet operations gap 114. As illustrated in FIGS. 1A through 4B, droplet 124 is a 4× droplet, meaning that droplet 124 has a footprint which spans about 4 droplet operations electrodes 116.

As illustrated in FIGS. 1A and 1B, droplet 124 spans the boundary between ground-electrode-region 126 and non-ground-electrode-region 128. In FIGS. 1A and 1B, droplet operations electrodes 116D, 116E, and 116F are deactivated (i.e., turned OFF) and droplet operations electrode 116G is activated (i.e., turned ON). The droplet operations electrode 116G is activated using, for example, an alternating current (AC) voltage.

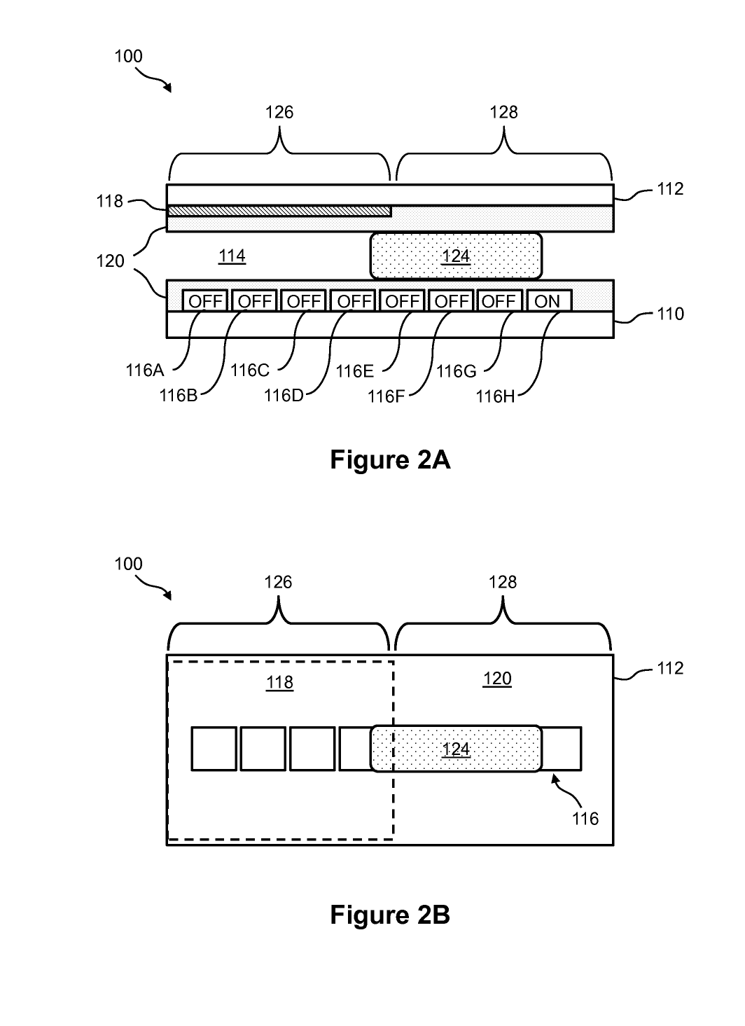

As illustrated in FIGS. 2A and 2B, droplet 124 is further transported out of ground-electrode-region 126 and into non-ground-electrode-region 128 by activating droplet operations electrode 116H and deactivating droplet operations 116G, and with droplet operations electrodes 116D, 116E, and 116F remaining deactivated. The droplet operations electrode 116H is activated using, for example, an AC voltage.

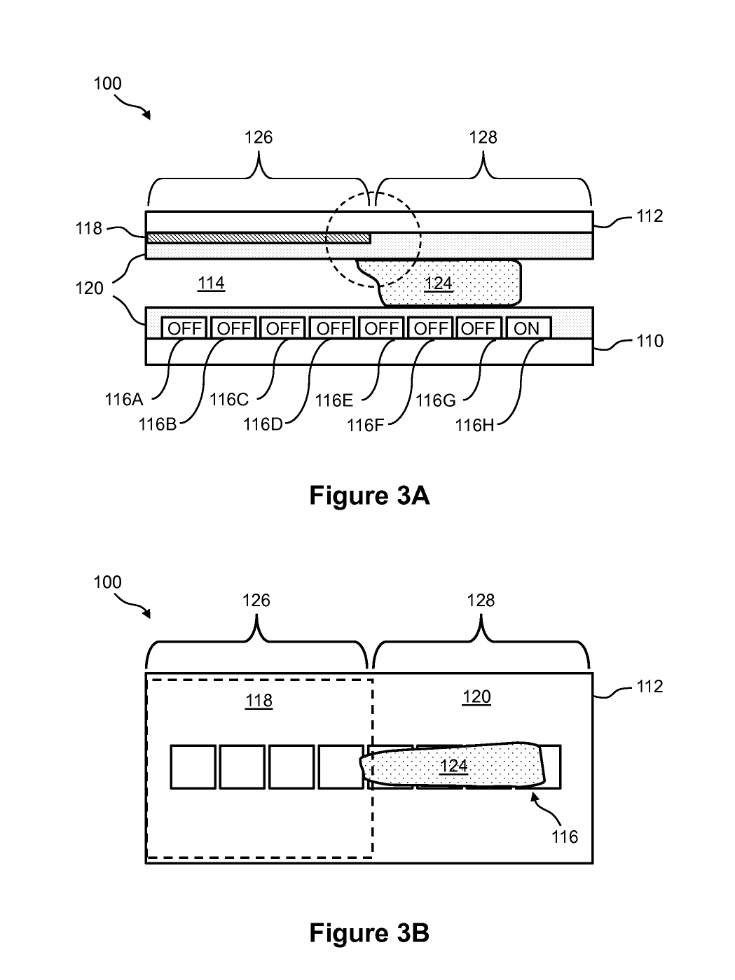

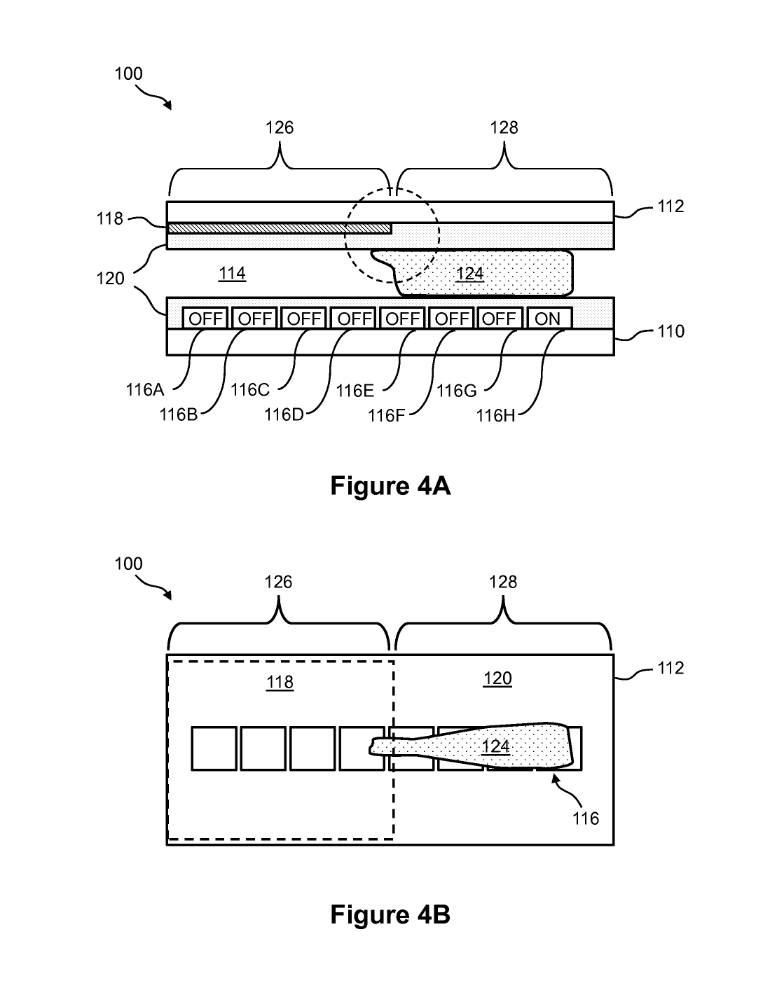

As illustrated in FIGS. 3A and 3B and FIGS. 4A and 4B, as droplet 124 is transported out of ground-electrode-region 126 and into non-ground-electrode-region 128, the area of droplet 124 in contact with top substrate 112 in ground-electrode-region 126 is substantially reduced. As the area of droplet 124 in contact with top substrate 112 in ground-electrode-region 126 is substantially reduced, an electrostatic a force on top substrate 112 is generated and droplet 124 is pinned or pulled back into the ground-electrode-region 126. Because droplet 124 is pinned, droplet 124 cannot move completely out of the ground-electrode-region 126 and into the non-ground-electrode-region 128.

The capacitive energy of droplet 124 may be calculated as the droplet 124 is transported across the boundary between ground-electrode-region 126 and non-ground-electrode-region 128. As droplet 124 transitions from ground-electrode-region 126 to non-ground-electrode-region 128, the energy of the droplet changes relative to its position on an active droplet operations electrode 116 at the boundary of the ground-electrode-region 126 and the non-ground-electrode-region 128 and an energy well is formed (not shown). An energy well is a stable position of a droplet, wherein additional energy is needed in order to move the droplet away from this stable equilibrium position. Namely, in this stable equilibrium position, the forces are balanced between the pulling forward force and the pulling back force. The formation of an energy well indicates that there is a stable equilibrium situation before the droplet completely to the next electrode. The formation of an energy well is associated with droplet pinning or pull back. As the surface area of droplet 124 on top substrate 112 in ground-electrode-region 126 is reduced, a force on top substrate 112 is generated pulling back droplet 124.

In one embodiment, the invention provides methods for reducing or entirely preventing droplet “pinning” or “pull-back” as the a droplet is transported across a boundary between a ground-electrode-region and a non-ground-electrode-region on a top substrate of a droplet actuator (i.e., as the droplet is transported from a ground-electrode-region to an adjacent non-ground-electrode-region on a top substrate of a droplet actuator).

In another embodiment, droplet pinning or pull-back as the droplet is transported across the boundary between the ground-electrode-region and the non-ground-electrode-region may be reduced or entirely prevented by increasing the size of droplet 124. Transporting a smaller droplet (e.g., a 2× droplet) across the boundary between the ground-electrode-region and the non-ground-electrode-region is more difficult; the energy required to overcome an energy well increases as droplet size decreases and the force on the top substrate pulling back the droplet also increases as droplet size decreases (not shown).

In another embodiment, droplet pinning or pull-back as the droplet is transported across the boundary between the ground-electrode-region and the non-ground-electrode-region may be reduced or entirely prevented by increasing the thickness of the hydrophobic layer 120 on top substrate 112. As the thickness of hydrophobic layer 120 (e.g., an amorphous fluoropolymer, such as CYTOP) is increased, the observed energy well decreases (not shown). In one embodiment, the thickness of hydrophobic layer 120 is a sufficient thickness to facilitate droplet transport across the boundary between the ground-electrode-region and the non-ground-electrode-region. In a particular embodiment, the thickness of hydrophobic layer 120 may be about 5 μm.

In yet another embodiment, droplet pinning or pull-back as the droplet is transported across the boundary between the ground-electrode-region and the non-ground-electrode-region may be reduced or entirely prevented by adding a dielectric layer on top substrate 112. In one example, the dielectric layer is formed of polyimide (KAPTON®).

In yet another embodiment, droplet pinning or pull-back as the droplet is transported across the boundary between the ground-electrode-region and the non-ground-electrode-region may be reduced or entirely prevented by using a direct current (DC) voltage instead of an AC voltage to activate the appropriate droplet operations electrodes 116, for example as droplet 124 is transported across the boundary between ground-electrode-region 126 and non-ground-electrode-region 128.

In yet another embodiment, droplet pinning or pull-back as the droplet is transported across the boundary between the ground-electrode-region and the non-ground-electrode-region may be reduced or entirely prevented by providing a line of conductive material extending from the ground-electrode-region and into the non-ground-electrode-region (i.e., a line of conductive material that spans the boundary between the ground-electrode-region and the non-ground-electrode-region).

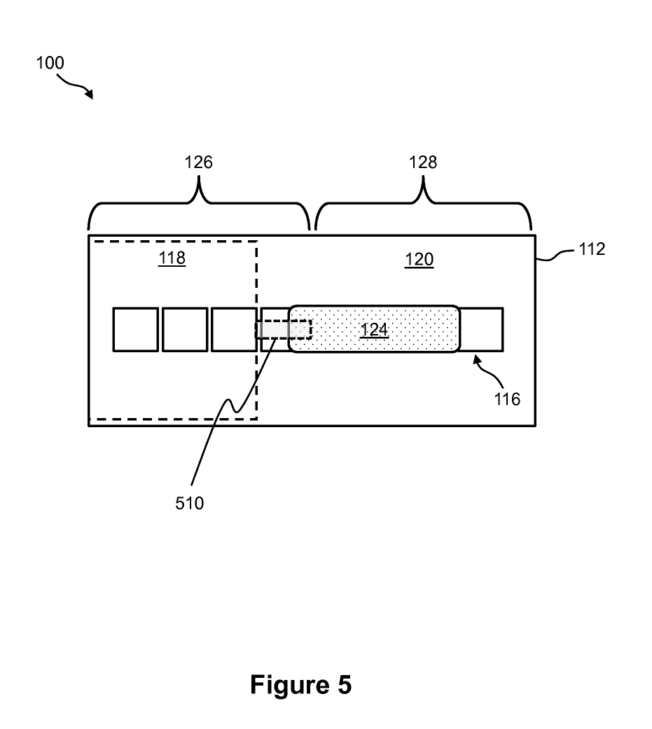

FIG. 5 illustrates a top view of droplet actuator 100 of FIGS. 1A through 4B, wherein the coverage of the electrically conductive material is reduced in the region of the top substrate 112 that includes the ground electrode 118. In one embodiment, the width of the ground electrode 118 in ground-electrode-region 126 is reduced to form a path 510 that spans the boundary between ground-electrode-region 126 and non-ground-electrode-region 128. As the width of path 510 (e.g., PEDOT) is decreased, the energy well associated with droplet pinning also decreases (not shown). In one embodiment, the width of path 510 is a sufficient width to facilitate droplet transport across the boundary between ground-electrode-region 126 and non-ground-electrode-region 128. In a particular embodiment, the width of path 510 may be about 120 μm.

In another embodiment, the invention provides methods for reducing or entirely preventing “super-movement” of a droplet as the droplet is transported across a boundary between a ground-electrode-region and a non-ground-electrode-region on a top substrate of a droplet actuator (i.e., as the droplet is transported from a ground-electrode-region to an adjacent non-ground-electrode-region on a top substrate of a droplet actuator). “Super-movement” of a droplet as used herein means random movement of a droplet that is independent of the droplet operations electrodes and faster than the actual actuation sequence. Super-movement of a droplet may occur, for example, as a result of the accumulation of static charge as the droplet is transported across the boundary between the ground-electrode-region and the non-ground-electrode-region on the top substrate of the droplet actuator, particularly wherein the top substrate of the droplet actuator is formed of a material that accumulates a static charge, such as a polycarbonate.

In one embodiment, super-movement of the droplet as it is transported across the boundary between the ground-electrode-region and the non-ground-electrode-region may be reduced or entirely prevented by deionizing the top substrate of the droplet actuator. The top substrate of the droplet actuator may, for example, be deionized before assembly of the droplet actuator cartridge. Alternatively, the top substrate of the droplet actuator may be deionized after assembly of the droplet actuator cartridge. In either case, the top substrate of the droplet actuator may be deionized using ESD ionizer (e.g., ElectraFlow® SL-001, available from United Static Control Products (Colorado City, Colo.)) placed close to the surface to be deionized.

In another embodiment, super-movement of the droplet as it is transported across the boundary between the ground-electrode-region and the non-ground-electrode-region may be reduced or entirely prevented by coating a portion of the top substrate that is facing away from the droplet operations gap with a conductive coating.

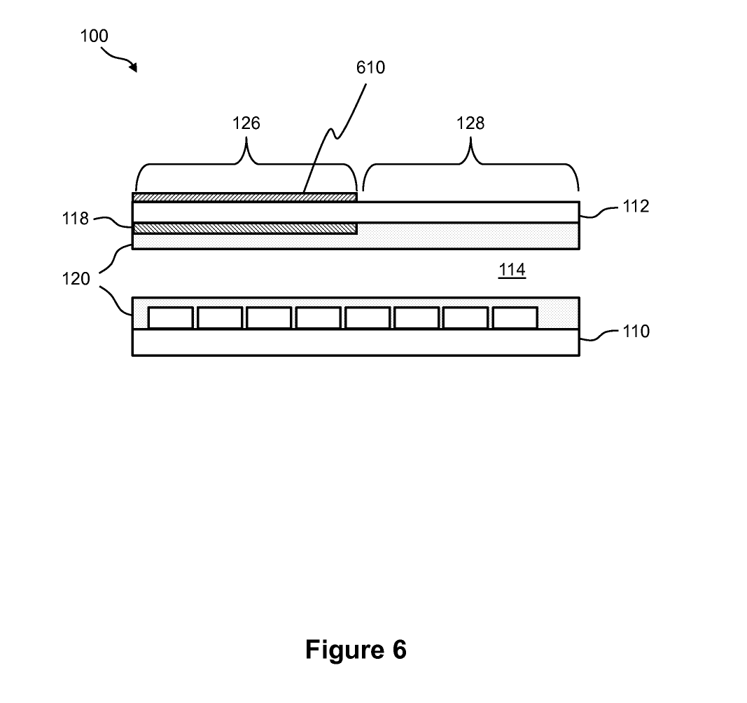

FIG. 6 illustrates a top view of droplet actuator 100 of FIGS. 1A through 4B, wherein a portion of the surface of the top substrate 112 that is facing away from the droplet operations gap 114 includes a conductive coating. In this example, a conductive coating 610 is disposed on a portion of top of substrate 112 in ground-electrode-region 126 that is facing away from droplet operations gap 114. In one example, conductive coating 610 is formed of PEDOT-PSS. As illustrated, conductive coating 610 is formed as a continuous layer on top substrate 112. In another example, conductive coating 610 may be formed as an array of islands of conductive material on top substrate 112. In yet another example, lines of the conductive coating 610 may be formed in a grid pattern on top substrate 112. Static charges that may accumulate on top substrate 112 are discharged via conductive coating 610, thereby reducing or eliminating super-movement of the droplet as it is transported across the boundary between ground-electrode-region 126 and non-ground-electrode-region 128.

### 7.2 Systems

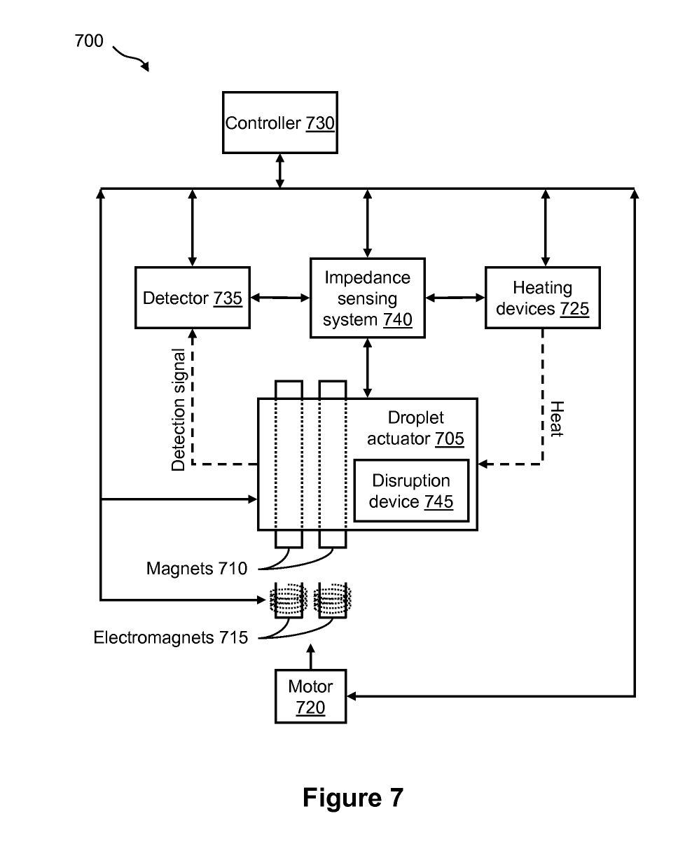

FIG. 7 illustrates a functional block diagram of an embodiment of a microfluidics system 700 that includes a droplet actuator 705. Digital microfluidic technology conducts droplet operations on discrete droplets in a droplet actuator, such as droplet actuator 705, by electrical control of their surface tension (electrowetting). The droplets may be sandwiched between two substrates of droplet actuator 705, a bottom substrate and a top substrate separated by a droplet operations gap. The bottom substrate may include an arrangement of electrically addressable electrodes. The top substrate may include a reference electrode plane made, for example, from conductive ink or indium tin oxide (ITO). The bottom substrate and the top substrate may be coated with a hydrophobic material. Droplet operations are conducted in the droplet operations gap. The space around the droplets (i.e., the gap between bottom and top substrates) may be filled with an immiscible inert fluid, such as silicone oil, to prevent evaporation of the droplets and to facilitate their transport within the device. Other droplet operations may be effected by varying the patterns of voltage activation; examples include merging, splitting, mixing, and dispensing of droplets.

Droplet actuator 705 may be designed to fit onto an instrument deck (not shown) of microfluidics system 700. The instrument deck may hold droplet actuator 705 and house other droplet actuator features, such as, but not limited to, one or more magnets and one or more heating devices. For example, the instrument deck may house one or more magnets 710, which may be permanent magnets. Optionally, the instrument deck may house one or more electromagnets 715. Magnets 710 and/or electromagnets 715 are positioned in relation to droplet actuator 705 for immobilization of magnetically responsive beads. Optionally, the positions of magnets 710 and/or electromagnets 715 may be controlled by a motor 720. Additionally, the instrument deck may house one or more heating devices 725 for controlling the temperature within, for example, certain reaction and/or washing zones of droplet actuator 705. In one example, heating devices 725 may be heater bars that are positioned in relation to droplet actuator 705 for providing thermal control thereof.

A controller 730 of microfluidics system 700 is electrically coupled to various hardware components of the invention, such as droplet actuator 705, electromagnets 715, motor 720, and heating devices 725, as well as to a detector 735, an impedance sensing system 740, and any other input and/or output devices (not shown). Controller 730 controls the overall operation of microfluidics system 700. Controller 730 may, for example, be a general purpose computer, special purpose computer, personal computer, or other programmable data processing apparatus. Controller 730 serves to provide processing capabilities, such as storing, interpreting, and/or executing software instructions, as well as controlling the overall operation of the system. Controller 730 may be configured and programmed to control data and/or power aspects of these devices. For example, in one aspect, with respect to droplet actuator 705, controller 730 controls droplet manipulation by activating/deactivating electrodes.

In one example, detector 735 may be an imaging system that is positioned in relation to droplet actuator 705. In one example, the imaging system may include one or more light-emitting diodes (LEDs) (i.e., an illumination source) and a digital image capture device, such as a charge-coupled device (CCD) camera.

Impedance sensing system 740 may be any circuitry for detecting impedance at a specific electrode of droplet actuator 705. In one example, impedance sensing system 740 may be an impedance spectrometer. Impedance sensing system 740 may be used to monitor the capacitive loading of any electrode, such as any droplet operations electrode, with or without a droplet thereon. For examples of suitable capacitance detection techniques, see Sturmer et al., International Patent Publication No. WO/2008/101194, entitled “Capacitance Detection in a Droplet Actuator,” published on Aug. 21, 2008; and Kale et al., International Patent Publication No. WO/2002/080822, entitled “System and Method for Dispensing Liquids,” published on Oct. 17, 2002; the entire disclosures of which are incorporated herein by reference.

Droplet actuator 705 may include disruption device 745. Disruption device 745 may include any device that promotes disruption (lysis) of materials, such as tissues, cells and spores in a droplet actuator. Disruption device 745 may, for example, be a sonication mechanism, a heating mechanism, a mechanical shearing mechanism, a bead beating mechanism, physical features incorporated into the droplet actuator 705, an electric field generating mechanism, a thermal cycling mechanism, and any combinations thereof. Disruption device 745 may be controlled by controller 730.

It will be appreciated that various aspects of the invention may be embodied as a method, system, computer readable medium, and/or computer program product. Aspects of the invention may take the form of hardware embodiments, software embodiments (including firmware, resident software, micro-code, etc.), or embodiments combining software and hardware aspects that may all generally be referred to herein as a “circuit,” “module” or “system.” Furthermore, the methods of the invention may take the form of a computer program product on a computer-usable storage medium having computer-usable program code embodied in the medium.

Any suitable computer useable medium may be utilized for software aspects of the invention. The computer-usable or computer-readable medium may be, for example but not limited to, an electronic, magnetic, optical, electromagnetic, infrared, or semiconductor system, apparatus, device, or propagation medium. The computer readable medium may include transitory and/or non-transitory embodiments. More specific examples (a non-exhaustive list) of the computer-readable medium would include some or all of the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission medium such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Program code for carrying out operations of the invention may be written in an object oriented programming language such as Java, Smalltalk, C++ or the like. However, the program code for carrying out operations of the invention may also be written in conventional procedural programming languages, such as the “C” programming language or similar programming languages. The program code may be executed by a processor, application specific integrated circuit (ASIC), or other component that executes the program code. The program code may be simply referred to as a software application that is stored in memory (such as the computer readable medium discussed above). The program code may cause the processor (or any processor-controlled device) to produce a graphical user interface (“GUI”). The graphical user interface may be visually produced on a display device, yet the graphical user interface may also have audible features. The program code, however, may operate in any processor-controlled device, such as a computer, server, personal digital assistant, phone, television, or any processor-controlled device utilizing the processor and/or a digital signal processor.

The program code may locally and/or remotely execute. The program code, for example, may be entirely or partially stored in local memory of the processor-controlled device. The program code, however, may also be at least partially remotely stored, accessed, and downloaded to the processor-controlled device. A user's computer, for example, may entirely execute the program code or only partly execute the program code. The program code may be a stand-alone software package that is at least partly on the user's computer and/or partly executed on a remote computer or entirely on a remote computer or server. In the latter scenario, the remote computer may be connected to the user's computer through a communications network.

The invention may be applied regardless of networking environment. The communications network may be a cable network operating in the radio-frequency domain and/or the Internet Protocol (IP) domain. The communications network, however, may also include a distributed computing network, such as the Internet (sometimes alternatively known as the “World Wide Web”), an intranet, a local-area network (LAN), and/or a wide-area network (WAN). The communications network may include coaxial cables, copper wires, fiber optic lines, and/or hybrid-coaxial lines. The communications network may even include wireless portions utilizing any portion of the electromagnetic spectrum and any signaling standard (such as the IEEE 802 family of standards, GSM/CDMA/TDMA or any cellular standard, and/or the ISM band). The communications network may even include powerline portions, in which signals are communicated via electrical wiring. The invention may be applied to any wireless/wireline communications network, regardless of physical componentry, physical configuration, or communications standard(s).

Certain aspects of invention are described with reference to various methods and method steps. It will be understood that each method step can be implemented by the program code and/or by machine instructions. The program code and/or the machine instructions may create means for implementing the functions/acts specified in the methods.

The program code may also be stored in a computer-readable memory that can direct the processor, computer, or other programmable data processing apparatus to function in a particular manner, such that the program code stored in the computer-readable memory produce or transform an article of manufacture including instruction means which implement various aspects of the method steps.

The program code may also be loaded onto a computer or other programmable data processing apparatus to cause a series of operational steps to be performed to produce a processor/computer implemented process such that the program code provides steps for implementing various functions/acts specified in the methods of the invention.

### 8 CONCLUDING REMARKS

The foregoing detailed description of embodiments refers to the accompanying drawings, which illustrate specific embodiments of the invention. Other embodiments having different structures and operations do not depart from the scope of the present invention. The term “the invention” or the like is used with reference to certain specific examples of the many alternative aspects or embodiments of the applicants' invention set forth in this specification, and neither its use nor its absence is intended to limit the scope of the applicants' invention or the scope of the claims. This specification is divided into sections for the convenience of the reader only. Headings should not be construed as limiting of the scope of the invention. The definitions are intended as a part of the description of the invention. It will be understood that various details of the present invention may be changed without departing from the scope of the present invention. Furthermore, the foregoing description is for the purpose of illustration only, and not for the purpose of limitation.

1. A method for reducing or preventing droplet pinning as the droplet is transported across a boundary between a ground electrode region and a non-ground electrode region on a droplet actuator, comprising:
a. providing the droplet actuator, wherein the droplet actuator comprises:
i. a bottom substrate and a top substrate separated to form a droplet operations gap;
ii. a ground electrode disposed on a portion of the top substrate; and
iii. a linear arrangement of a plurality of droplet operations electrodes disposed on the bottom substrate, wherein the plurality of droplet operations electrodes spans the boundary between the ground electrode region and the non-ground electrode region;
b. positioning an elongated droplet on more than one of the plurality of droplet operations electrodes, wherein the elongated droplet is positioned atop at least one droplet operations electrode in the ground electrode region and at least one droplet operations electrode in the non-ground electrode region;
c. activating the at least one droplet operations electrode in the non-ground electrode region; and
d. activating the next droplet operations electrode of the linear arrangement in the non-ground electrode region and deactivating the at least one droplet operations electrode in the non-ground electrode region;
wherein the elongated droplet is transported out of the ground-electrode-region and into the non-ground electrode-region.

2. The method of claim 1, wherein the ground-electrode-region comprises the ground electrode, and wherein the ground electrode comprises a layer of electrically conductive material.

3. The method of claim 2, wherein the layer of electrically conductive material comprises poly(3,4-ethylenedioxythiophene) (PEDOT).

4. The method of claim 1, wherein the non-ground electrode-region does not comprise the ground electrode.

5. The method of claim 1, wherein a hydrophobic layer is disposed on the surface of the top substrate facing the droplet operations gap.

6. The method of claim 5, wherein the hydrophobic layer comprises an amorphous fluoropolymer.

7. The method of claim 1, wherein the hydrophobic layer is a sufficient thickness to facilitate droplet transport across the boundary between the ground-electrode-region and the non-ground electrode-region.

8. The method of claim 7, wherein the thickness of the hydrophobic layer is about 5 μm.

9. The method of claim 1, wherein the top substrate further comprises a dielectric layer.

10. The method of claim 9, wherein the dielectric layer comprises polyimide.

11. The method of claim 1, wherein activation of droplet operations electrodes comprises activation using an alternating current.

12. The method of claim 1, wherein activation of droplet operations electrodes comprises activation using a direct current.

13. The method of claim 1, further comprising providing a path of conductive material on the top substrate that spans the boundary between the ground electrode region and the non-ground electrode region of the droplet actuator.

14. The method of claim 13, wherein the path of electrically conductive material comprises poly(3,4-ethylenedioxythiophene) (PEDOT).

15. The method of claim 1, wherein the path of electrically conductive material is of a width sufficient to facilitate droplet transport across boundary between the ground electrode region and the non-ground electrode region of the droplet actuator.

16. The method of claim 15, wherein the width of the path of electrically conductive material is about 120 μm.

17. A method for reducing or preventing droplet super-movement as the droplet is transported across a boundary between a ground electrode region and a non-ground electrode region on a droplet actuator, comprising:
a. providing the droplet actuator, wherein the droplet actuator comprises:
i. a bottom substrate and a top substrate separated to form a droplet operations gap, wherein the top substrate is deionized;
ii. a ground electrode disposed on a portion of the top substrate; and
iii. an arrangement of droplet operations electrodes disposed on the bottom substrate; and
b. transporting the droplet out of the ground electrode region and into the non-ground electrode region by electrowetting.

18. A method for reducing or preventing droplet super-movement as the droplet is transported across a boundary between a ground electrode region and a non-ground electrode region on a droplet actuator, comprising:
a. providing the droplet actuator, wherein the droplet actuator comprises:
i. a bottom substrate and a top substrate separated to form a droplet operations gap, wherein a portion of the top substrate facing away from the droplet operations gap is coated with a conductive coating;
ii. a ground electrode disposed on a portion of the top substrate; and
iii. an arrangement of droplet operations electrodes disposed on the bottom substrate; and
b. transporting the droplet out of the ground electrode region and into the non-ground electrode region by electrowetting.

19. The method of claim 18, wherein the conductive coating comprises a continuous layer on the top substrate.

20. The method of claim 18, wherein the conductive coating comprises an array of islands of conductive material on the top substrate.

21. The method of claim 18, wherein the conductive coating comprises lines of conductive material in a grid pattern on the top substrate.

22. The method of claim 1, wherein the conductive coating comprises Poly(3,4-ethylenedioxythiophene) Polystyrene sulfonate.

23. A microfluidics system programmed to execute the method of claim 1 on the droplet actuator.

24. The microfluidics system of claim 23, wherein the droplet actuator is coupled to a processor that executes program code embodied in a storage medium for executing the method.

25. A storage medium comprising program code embodied in the medium for executing the method of claim 1 on the droplet actuator.

26. A microfluidics system programmed to execute the method of claim 17 on the droplet actuator.

27. The microfluidics system of claim 26, wherein the droplet actuator is coupled to a processor that executes program code embodied in a storage medium for executing the method.

28. A storage medium comprising program code embodied in the medium for executing the method of claim 17 on the droplet actuator.

29. A microfluidics system programmed to execute the method of claim 18 on the droplet actuator.

30. The microfluidics system of claim 29, wherein the droplet actuator is coupled to a processor that executes program code embodied in a storage medium for executing the method.

31. A storage medium comprising program code embodied in the medium for executing the method of claim 18 on the droplet actuator.
